(19) United States
(12) Patent Application Publication
(10) Pub. No.: US 2011/0235812 A1
(43) Pub. Date: Sep. 29, 2011

(54) SOUND INFORMATION DETERMINING APPARATUS AND SOUND INFORMATION DETERMINING METHOD

(76) Inventors: Hiroshi Yonekubo, Tokyo (JP); Hirokazu Takeuchi, Tokyo (JP)

(21) Appl. No.: 12/965,586

(22) Filed: Dec. 10, 2010

(30) Foreign Application Priority Data
Mar. 25, 2010 (JP) JP 2010-070797

(51) Int. Cl. H04R 29/00; G10L 15/20

(52) U.S. Cl. 381/56; 704/233; 704/E15.039

(57) ABSTRACT

According to one embodiment, a sound information determining apparatus includes: a holding module configured hold a plurality of determining techniques, each of which determines, with respect to a noise of each type that may be present in an input audio signal, whether the noise of corresponding type is present according to a noise characteristic; and a determining module configured to determine whether noise is present in the input audio signal by making use of some of the plurality of the determining techniques held with respect to the noise of each type.

### CROSS-REFERENCE TO RELATED APPLICATIONS

This application is based upon and claims the benefit of priority from Japanese Patent Application No. 2010-070797, filed Mar. 25, 2010, the entire contents of which are incorporated herein by reference.

### FIELD

Embodiments described herein relate generally to a sound information determining apparatus and a sound information determining method.

### BACKGROUND

As is known in the art, for example, in broadcast receivers that receive television broadcast or information reproducing apparatuses that reproduce recorded information from an information recording medium; the reproduction of audio signals from the received broadcast signals or from the signals read from an information recording medium is accompanied by sound quality correction of those audio signals. That enables achieving a higher degree of sound quality.

In this case, regarding the sound quality correction performed on an audio signal, the details depend on whether noise is present in the audio signal.

In regard to that point, a technology has been proposed for performing noise determination on a section-by-section basis in an audio signal.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a configuration of a main signal processing system of a digital television broadcast receiver according to a first embodiment;

FIG. 2 is an exemplary block diagram of a configuration of an audio processing module in the digital television broadcast receiver in the embodiment;

FIG. 3 illustrates various levels extracted from an input audio signal by the audio processing module for the purpose of sound quality correction;

FIG. 4 is an exemplary flowchart of the sequence of operations that are associated to the noise present in an audio signal and that are performed in the audio processing module in the embodiment;

FIG. 5 is an exemplary flowchart for explaining the sequence of operations in a method of generating feature quantity parameters that is implemented by a noise feature quantity extracting module in the embodiment;

FIG. 6 is an exemplary flowchart for explaining the sequence of operations in a method of calculating a base score Sn_base as the base of the noise level that is implemented by a noise level determining module in the embodiment;

FIG. 7 is a flowchart for explaining the sequence of operations in a method of calculating the base score Sn_base as the initial value of the noise level that is implemented by a noise level correcting module in the embodiment; and

FIG. 8 is an exemplary flowchart for explaining the sequence of operations in a method of correcting the music level that is implemented by a level adjusting module in the embodiment.

### DETAILED DESCRIPTION

In general, according to one embodiment of the invention, a sound information determining apparatus comprises: a holding module configured to hold a plurality of determining techniques, each of which determines, with respect to a noise of each type that may be present in an input audio signal, whether the noise of corresponding type is present according to a noise characteristic; and a determining module configured to determine whether noise is present in the input audio signal by making use of some of the plurality of the determining techniques held with respect to the noise of each type.

According to another embodiment, a sound information determining method implemented in a sound information determining apparatus including a memory module configured to store a plurality of determining techniques each of which determines, with respect to a noise of each type that may be present in an input audio signal, whether the noise of corresponding type is present according to a noise characteristic, the sound information determining method comprises: determining, by a determining module, whether noise is present in the input audio signal by making use of the plurality of the determining techniques stored in the memory module with respect to the noise of each type.

Various embodiments of a sound information determining apparatus and a sound information determining method will be described hereinafter with reference to the accompanying drawings.

### First Embodiment

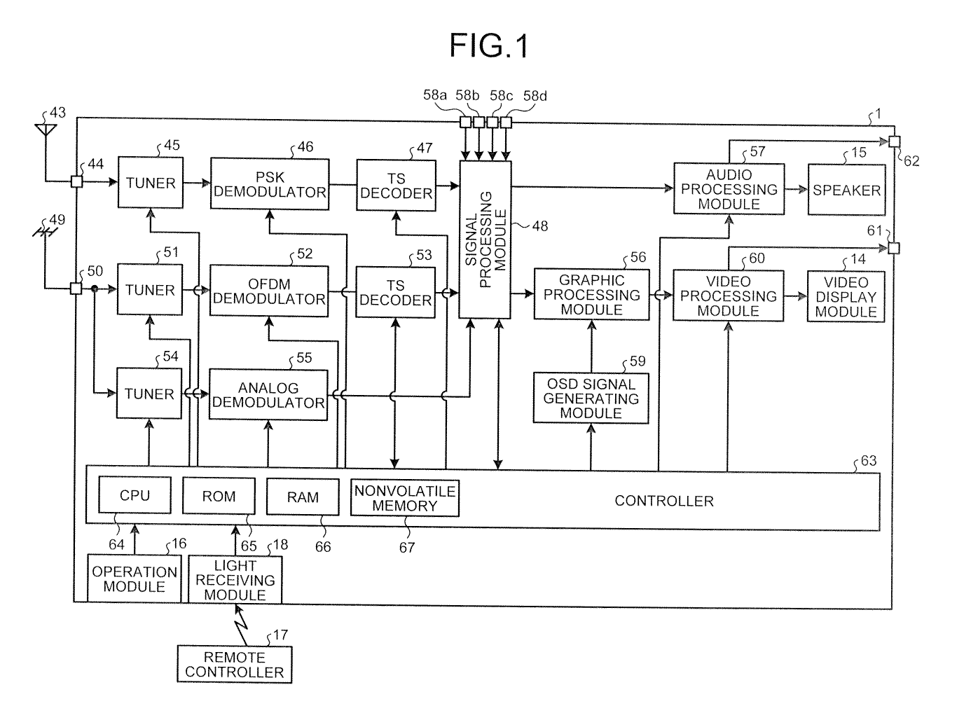

FIG. 1 illustrates a main signal processing system of a digital television broadcast receiver 1 according to a first embodiment. Herein, satellite digital television broadcast signals that are received by a BS/CS (broadcasting satellite/communication satellite) digital broadcast receiving antenna 43 are fed to a digital satellite broadcasting tuner 45 via an input terminal 44, so that broadcast signals for the intended channel are selected.

The broadcast signals selected at the tuner 45 are then fed to a phase shift keying (PSK) demodulator 46 and to a transport stream (TS) decoder 47 in that order. Consequently, the broadcast signals are demodulated in digital video signals and digital audio signals, which are then output to a signal processing module 48.

Meanwhile, digital terrestrial television broadcast signals that are received by a terrestrial broadcast receiving antenna 49 are fed to a digital terrestrial broadcasting tuner 51 via an input terminal 50, so that broadcast signals for the intended channel are selected.

The broadcast signals selected at the tuner 51 are then fed to, for example (in Japan), an orthogonal frequency division multiplexing (OFDM) demodulator 52 and to a TS decoder 53 in that order. Consequently, the broadcast signals are demodulated in digital video signals and digital audio signals, which are then output to the signal processing module 48.

Moreover, analog terrestrial television broadcast signals that are also received by the terrestrial broadcast receiving antenna 49 are fed to an analog terrestrial broadcasting tuner 54 via the input terminal 50, so that broadcast signals for the intended channel are selected. The broadcast signals selected at the tuner 54 are then fed to an analog demodulator 55 and are demodulated in analog video signals and analog audio signals. Those signals are then output to the signal processing module 48.

With respect to the digital video signals and the digital audio signals received from each of the TS decoders 47 and 53, the signal processing module 48 selectively performs predetermined signal processing, and outputs the processed video signals to a graphic processing module 56 and outputs the processed audio signals to an audio processing module 57.

To the signal processing module 48 are connected a plurality of (four in FIG. 1) input terminals 58a, 58b, 58c, and 58d. Each of the input terminals 58a to 58d can be used to input analog video signals and analog audio signals from the outside of the digital television broadcast receiver 1.

With respect to the analog video signals and the analog audio signals received via the analog demodulator 55 and received via each of the input terminals 58a to 58d; the signal processing module 48 selectively performs digitalization. Then, on the digitalized video signals and the digitalized audio signals, the signal processing module 48 performs predetermined digital signal processing, and outputs the processed video signals to the graphic processing module 56 and the processed audio signals to the audio processing module 57.

The graphic processing module 56 superimposes on-screen display (OSD) signals that are generated by an OSD signal generating module 59 on the digital video signals output by the signal processing module 48 and then outputs the superimposed signals. More particularly, the graphic processing module 56 can selectively output the digital video signals received from the signal processing module 48 or the OSD signals generated by the OSD signal generating module 59, or can output a combination of the digital video signals and the OSD signals in such a way that each type of signals constitutes one-half of a screen.

The digital video signals output from the graphic processing module 56 are fed to a video processing module 60, which converts those digital video signals into analog video signals having a format displayable on a video display module 14 and then outputs those analog video signals to the video display module 14 for display. Besides, the video processing module 60 guides the analog video signals to the outside via an output terminal 61.

The audio processing module 57 first performs sound quality correction (described later) on the digital audio signals input thereto and then converts the corrected signals into analog audio signals having a format re-playable in a speaker 15. Apart from being output to the speaker 15 for audio replaying, the analog audio signals are guided to the outside via an output terminal 62.

In the digital television broadcast receiver 1, all operations including the abovementioned various reception operations are integratedly controlled by a controller 63, which houses a central processing unit (CPU) 64. The controller 63 receives operation information from an operation module 16 or receives operation information that has been received by a light receiving module 18 from a remote controller 17, and controls each module to carry out the operations specified in the operation information.

For that, the controller 63 mainly makes use of a read only memory (ROM) 65 that stores therein the control programs to be executed by the CPU 64, a random access memory (RAM) 66 that provides a work area to the CPU 64, and a nonvolatile memory 67 that stores therein a variety of configuration information and control information.

Besides, via a card interface (I/F) (not illustrated), the controller 63 is connected to a first card holder (not illustrated) in which a first memory card (not illustrated) can be inserted. Once the first memory card is inserted in the first card holder, the controller 63 can communicate information with the first memory card via the card I/F.

Moreover, via a card I/F (not illustrated), the controller 63 is connected to a second card holder (not illustrated) in which a second memory card (not illustrated) is inserted. Once the second memory card is inserted in the second card holder, the controller 63 can communicate information with the second memory card via the card I/F.

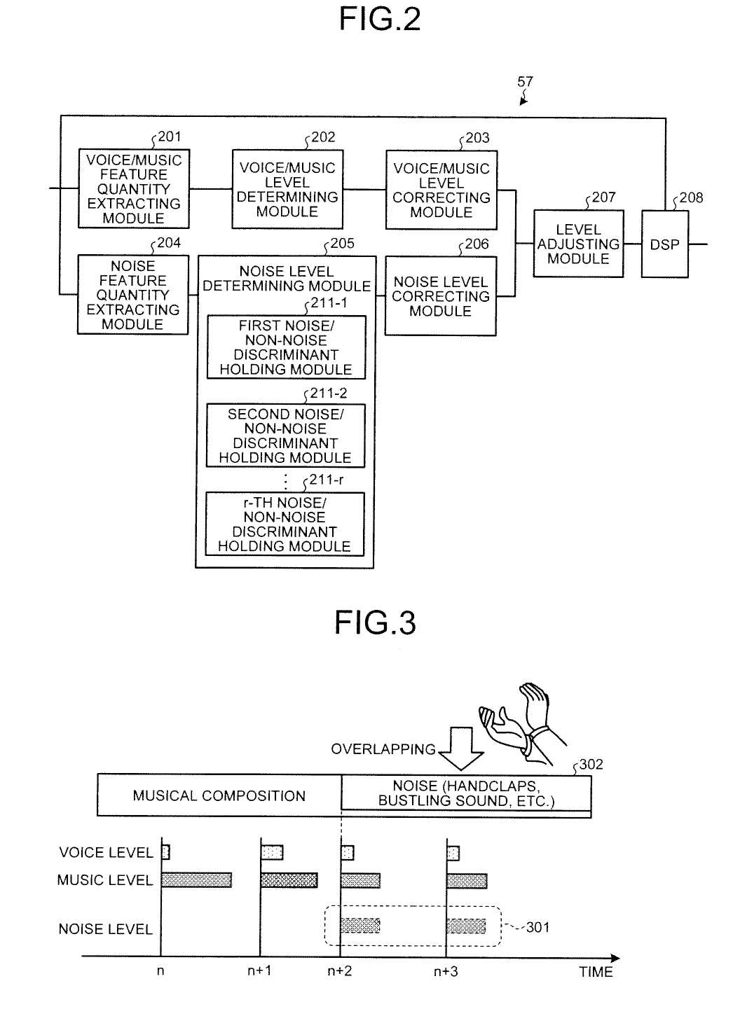

Described below is a configuration of the audio processing module 57. FIG. 2 is an exemplary block diagram of a configuration of the audio processing module 57 in the digital television broadcast receiver 1 according to the first embodiment.

As illustrated in FIG. 2, the audio processing module 57 comprises a voice/music feature quantity extracting module 201, a voice/music level determining module 202, a voice/music level correcting module 203, a noise feature quantity extracting module 204, a noise level determining module 205, a noise level correcting module 206, a level adjusting module 207, and a digital signal processor (DSP) 208. Explained below is the outline of the operations performed by the audio processing module 57.

FIG. 3 illustrates various levels extracted from an input audio signal by the audio processing module 57 according to the present embodiment for the purpose of sound quality correction. As illustrated in FIG. 3, on a frame-by-frame basis (for example, n, n+1, n+2, n+3, and so on) of an input audio signal, the audio processing module 57 identifies a voice level, a music level, and a noise level and then performs sound quality correction on the basis of those levels calculated for each frame. Herein, a frame according to the present embodiment represents the data length obtained by partitioning an audio signal at a predetermined first time period (of, for example, a few hundred of milliseconds).

In FIG. 3, the voice level indicates the extent to which the input audio signal represents voice. Thus, higher the voice level, greater is the possibility that the audio signal represents voice. The music level indicates the extent to which the input audio signal represents music. Thus, higher the music level, greater is the possibility that the audio signal represents music.

Meanwhile, the voice level and the music level are not confined to mutually independent levels and can also be integrated into a voice/music level. Lower the voice/music level, greater is the voice-likeness; and higher the voice/music level, greater is the music-likeness.

The noise level indicates the extent to which the audio signal contains noise. Higher the noise level, greater is the possibility that the audio signal contains a lot of noise.

As illustrated in FIG. 3, the detected music level is high for a musical composition section in the input audio signal. For a high music level, the DSP 208 (described later) performs sound quality correction that is suitable for the musical composition. In contrast, for a talk section when the musical composition is stopped or for a section of the musical composition during which only vocalists sing, the detected music level decreases but the detected voice level increases. Hence, the DSP 208 (described later) performs sound quality correction that is suitable for voice. In this way, depending on the extent to which music or voice is detected, it is possible to perform extensive sound quality control.

Meanwhile, there also exists a section 302 that is overlapped by noise that is detrimental to sound quality correction intended for music or voice. In the section 302, the audio processing module 57 extracts, from the input audio signal, a noise level 301 representing the noiseness of the signal. Then, the audio processing module 57 performs sound quality correction according to the extracted noise level 301. For example, for a high noise level, one of the ways can be to refrain from performing sound quality correction. Herein, for example, the noise that gets extracted can be the handclaps that overlap before or after the performance of the musical composition or can be the bustling sound that tends to get caught while filming a news show or a variety show on the street.

In this way, depending on whether noise is present in an input audio signal, the audio processing module 57 according to the present embodiment performs different sound quality correction on a section-by-section basis.

As a result, at the time of reproducing the contents received during the broadcast reception or received from a recording medium, the audio processing module 57 performs scene-based sound quality correction suitable to the audio signals. That enables achieving a high degree of sound quality.

In the present embodiment, the explanation is given with reference to an example of determining the handclaps or the bustling sound as the noise with a high degree of accuracy. That is, in the present embodiment, the explanation is given with reference to undesired sounds such as the handclaps or the bustling sound that generally overlap on the music or the voice in an unexpected manner. However, alternatively, it is also possible to consider other types of noise such as a constantly overlapping noise (for example, sound of a working air conditioner) as the determination target.

The voice/music feature quantity extracting module 201 calculates, from an audio signal, various feature quantity parameters for the purpose of determining whether the audio signal is a voice signal or a music signal. In the present embodiment, the voice/music feature quantity extracting module 201 partitions an audio signal into frames and divides each frame into subframes, each of which represents the data length of tens of milliseconds. Then, the voice/music feature quantity extracting module 201 calculates discrimination information such as power or zero cross frequency on a subframe-by-subframe basis, calculates a statistic such as a mean and a variance on a frame-by-frame basis by making use of the subframe-by-subframe discrimination information, and sets that statistic as a feature quantity parameter. Meanwhile, the calculation method is not limited to the above-mentioned description and it is also possible to implement any other method including the known methods. Besides, although power or zero cross frequency is used as the discrimination information for the purpose of calculating a feature quantity parameter, the discrimination information can be any type of information that helps in distinguishing between voice and music.

The voice/music level determining module 202 calculates, from the extracted feature quantity parameter, the voice level and the music level that include accuracy information used for extensive sound quality control. For example, for an audio signal representing music, since the musical sounds output from left and right are not the same, the left/right power ratio tends to be large. The voice/music level determining module 202 makes use of that trend for calculating the music level.

More particularly, the voice/music level determining module 202 substitutes the feature quantity parameter, which has been extracted by the voice/music feature quantity extracting module 201, in a predetermined discriminant and calculates base scores that lead to the extraction of the voice level and the music level. As the predetermined discriminant, it is possible to use the linear discriminant that has been proposed in the past. Meanwhile, the discriminant can be changed depending on whether an audio signal is stereo or monaural or can be configured to have a multistage structure.

With respect to each base score calculated by the voice/music level determining module 202, the voice/music level correcting module 203 performs smoothing and correction of voice and music in an independent manner, and generates the voice level and the music level. At that time, the linear discriminant that enables only the exclusive determination of voice or music is applied to each base score so that the voice level and the music level representing the extent of voice-likeness and the extent of music-likeness, respectively, can be calculated in an independent manner.

As a detailed example, based on the base scores calculated within a certain period of time, the voice/music level correcting module 203 performs correction of each base score while referring to the detection status of the music level and the voice level in that certain period of time. For example, if the musical composition includes silence for a short period of time, then the calculated base score for the music level indicates a low value. In that case, depending on the music level of the previous frame and the music level of the next frame, the voice/music level correcting module 203 performs correction of the base score for the music level and then obtains the music level using the corrected base score. Meanwhile, the method of obtaining the music level from the base score can be any method including the known methods.

Thus, even during a musical composition, a section having a low base score for the music level is corrected to have the appropriate music level. A similar correction is performed with respect to the voice level too. In this way, in the present embodiment, in order to achieve stability in the voice level and the music level, correction of each level is performed on the basis of determination continuity and the magnitude of determination values, and so on.

The noise feature quantity extracting module 204 calculates, from an audio signal, various feature quantity parameters for the purpose of determining whether the audio signal contains noise. In the present embodiment, in an identical manner to that of the voice/music feature quantity extracting module 201, the noise feature quantity extracting module 204 partitions an audio signal into frames and divides each frame into subframes. Then, the noise feature quantity extracting module 204 calculates a variety of discrimination information on a subframe-by-subframe basis, calculates a statistic such as a mean and a variance on a frame-by-frame basis by making use of the subframe-by-subframe discrimination information, and sets that statistic as a feature quantity parameter. Herein, the discrimination information can be any type of information that helps in determining whether the audio signal contains noise.

In the present embodiment, as one type of the discrimination information used for extracting the noise characteristic, the spectral flatness measure (SFM) is used that focuses on the flatness of the frequency characteristic. Generally, higher the noise-like property of a signal, flatter is the frequency spectrum and higher is the SFM value. That trend is put to use as the noise characteristic. The SFM is calculated by Equation (1) given below.

$$SFM = \frac{\sqrt[N]{{∐}_{k = 0}^{N - 1} {X ( k )}^{2}}}{\frac{{\sum }_{k = 0}^{N - 1} {X ( k )}^{2}}{N}} \qquad ( 1 )$$

Thus, by performing fast Fourier transform (FFT) with respect to the audio signal, the noise feature quantity extracting module 204 divides the calculated spectrum power into a plurality of bandwidths and calculates the SFM value. Then, the noise feature quantity extracting module 204 sets a feature quantity parameter by performing weighting of the bandwidth-based SFMs. Equation (2) given below is the formula for calculating that feature quantity parameter.

$$SFM\_subband = {α}_{1} \frac{\sqrt[{N}_{1}]{{∐}_{k = 0}^{{N}_{1} - 1} {X ( k )}^{2}}}{\frac{{\sum }_{k = 0}^{{N}_{1} - 1} {X ( k )}^{2}}{{N}_{1}}} + {α}_{2} \frac{\sqrt[{N}_{2}]{{∐}_{k = {N}_{1}}^{{N}_{2} - 1} {X ( k )}^{2}}}{\frac{{\sum }_{k = {N}_{1}}^{{N}_{2} - 1} {X ( k )}^{2}}{{N}_{2} - {N}_{1}}} + … + {α}_{p} \frac{\sqrt[{N}_{p}]{{∐}_{k = {N}_{p - 1}}^{{N}_{p} - 1} {X ( k )}^{2}}}{\frac{{\sum }_{k = {N}_{p - 1}}^{{N}_{p} - 1} {X ( k )}^{2}}{{N}_{p} - ( {N}_{p - 1} )}} \qquad ( 2 )$$

In Equation (2), variables N₁ to Nₚ represent p number of divided bandwidths, and α₁ to αₚ represent weighting coefficients having the summation equal to one. Herein, by using different weighting coefficients for each type of noise, the feature quantity parameter calculated by Equation (2) has a different value.

For example, from bandwidths having significant flatness due to the noise that represents the handclaps, a plurality of bandwidths are selected and a feature quantity for the handclaps is calculated using weighting coefficients that are set for the purpose of defining the features of the handclaps. Similarly, from bandwidths having significant flatness due to the noise that represents the bustling sound, a plurality of bandwidths are selected and a feature quantity for the bustling sound is calculated using weighting coefficients that are set for the purpose of defining the features of the bustling sound.

In this way, for each type of noise to be determined, the noise feature quantity extracting module 204 according to the present embodiment selects a plurality of suitable bandwidths and calculates a feature quantity for that type of noise using Equation (2), in which weighting coefficients suitable to that type of noise are set in each selected bandwidth.

Meanwhile, although the SFM is an efficient feature quantity for noise determination, the accuracy of noise determination can be further enhanced by using another parameter in combination with the SFM. Thus, in the present embodiment, the noise feature quantity extracting module 204 extracts some more parameters other than the SFM as feature quantity parameters.

As another feature quantity parameter that is effective in extracting the noise-like property, the noise feature quantity extracting module 204 extracts the resemblance with white noise. That is because the undesired sound such as the bustling sound has a resembling property to white noise. Thus, by selecting a feature quantity close to white noise as the feature quantity parameter of the bustling sound, the noise extraction can be performed more effectively.

The noise feature quantity extracting module 204 holds in advance a representative signal representing white noise as an ideal noise signal, representative various signals to be considered as noise, and a representative signal of the voice/music signals not to be considered as noise. Then, as the feature quantity of the signals to be considered as noise such as the bustling sound extracted from an input audio signal, the noise feature quantity extracting module 204 selects a feature quantity that exhibits a feature quantity distribution resembling to white noise as compared to the voice/music.

Besides, depending on the music, often times a sound component such as a high-frequency noise (attributed to the use of percussions or synthesizers) is present. In order to prevent such a sound component from being erroneously detected as noise, the noise feature quantity extracting module 204 can be configured to extract, in addition to the flatness of signals, a feature quantity focusing on the musical structure. For example, the noise feature quantity extracting module 204 can be configured to extract a feature quantity indicating whether there is strong excitation of the harmonic sound component corresponding to the musical scale. By extracting such a feature quantity, it becomes possible to prevent a situation when noise is erroneously detected in some music.

Regarding the discrimination information, apart from the SFM, it is also possible to use any feature quantity that is effective in extracting the noise-like property. Besides, that feature quantity can also be used in common with the feature quantity intended for voice/music. Meanwhile, the noise feature quantity extracting module 204 according to the present embodiment extracts m number of feature quantity parameters, where “m” is determined to be a number suitable to the specific mode.

The noise level determining module 205 comprises r number of noise/non-noise discriminant holding modules. With the use of feature quantity parameters extracted from the audio signal and with the use of the discriminant held by each of the r number of noise/non-noise discriminant holding modules, the noise level determining module 205 estimates whether the audio signal contains noise and, from the estimation result of each discriminant, determines whether noise is present. Herein, the r number of noise/non-noise discriminant holding modules are configured in the memory area of a memory module (for example, a hard disk drive (HDD)) of the digital television broadcast receiver 1. In the present embodiment, although all discriminants held by the r number of noise/non-noise discriminant holding modules are put to use for noise estimation, it is also possible to use only a plurality of the discriminants of all the discriminants without using all the discriminants for the purpose of noise estimation.

With respect to each type of noise that may be present in an audio signal, r number of noise/non-noise discriminant holding modules 211-1 to 211-r each holds a linear discriminant for determining whether that type of noise is present according to the characteristic of the undesired sounds. Meanwhile, the total count r of the discriminants held by the noise/non-noise discriminant holding modules is equal or greater than the number of types of the undesired sounds to be determined. For example, there can be separate discriminants for determining the handclaps mixed in music and for determining the handclaps mixed in voice.

Equation (3) given below is an exemplary linear discriminant held by the first noise/non-noise discriminant holding module 211-1.

Sn1=α₁χ₁+α₂χ₂+ . . . +αₘχₘ (3)

In χ₁ to χₘ are inserted the feature quantity parameters extracted by the noise feature quantity extracting module 204. In weighting coefficients α₁ to αₘ are set weighting coefficients according to the type of noise. The weighting coefficients α₁ to αₘ can be set to such numerical values that the addition thereof is equal to one.

For example, in order to determine the presence of handclap noise by making use of Equation (3), the weighting coefficients α₁ to αₘ are set with the numerical values suitable for the handclap noise. For example, large values are set in the weighting coefficients corresponding to feature quantity parameters close to the handclap noise. If the value of Sn1 calculated using Equation (3) is a positive value, then the handclap noise is determined to be present; while if the value of Sn1 calculated using Equation (3) is a negative value, then the handclap noise is determined to be absent. Meanwhile, regarding the determination based on positivity and negativity, the criterion is conveniently set at the time of learning. Thus, the handclap noise can be set to be either positive or negative. Moreover, the discriminants are not limited to the determination based on positivity and negativity as long as noise determination is possible.

Herein, the weighting coefficients α₁ to αₘ indicating the presence or absence of handclaps can also be adjusted by a user or can be calculated according to a learning algorithm.

Equation (4) given below is an exemplary linear discriminant held by the second noise/non-noise discriminant holding module 211-2. Herein, Equation (4) is assumed to be a linear discriminant for detecting the bustling sound.

Sn2=α′₁χ₁+α′₂χ₂+ . . . α′ₘχₘ (4)

It can be seen that the weighting coefficients α₁ to αₘ in Equation (3) are changed to weighting coefficients α′₁ to α′ₘ in Equation (4). The weighting coefficients α′₁ to α′ₘ are set with the numerical values suitable for bustling sound noise. Since it is assumed that the weighting coefficients α′₁ to α′ₘ are set with appropriate values by actual measurement, the specific numerical values are not mentioned herein.

Meanwhile, in each discriminant, a different feature quantity parameter can be used. For example, there can be times when an index such the SFM is not effective in identifying a particular sound type of undesired sounds. In such cases, it is important to select a feature quantity parameter according to the sound type of undesired sounds.

In this way, depending on the type of undesired sounds to be determined by the corresponding linear discriminant, suitable weighting coefficients are set.

Subsequently, based on the determination values Sn1 to Snr calculated as described above, the noise level determining module 205 calculates a base score Sn_base, which is considered to be the initial value for calculating the noise level. In this way, the base score Sn_base representing the noise-like property gets estimated. Meanwhile, the base score Sn_base is a parameter based on the discrimination results of the discriminants. For example, the base score Sn_base can be the total or the average of the discrimination results of the discriminants.

For each sound type such as handclaps or bustling sound that is to be classified as “noise”, the acoustic characteristic is different. Thus, the noise level determining module 205 holds a plurality of discriminants for each sound type and makes use of those discriminants for determining the sound types that are to be classified as noise. That makes it possible to perform highly accurate determination with respect to each sound type. Meanwhile, the weighting coefficients of the discriminants are assumed to be set by means of offline learning. However, it is also possible to use the weighting coefficients set by the user.

For example, in the case of using separate discriminants for distinguishing between the presence and absence of handclaps and distinguishing between the presence and absence of bustling sound, the number of r is two. Accordingly, by means of learning the reference data specific to the sections such as the handclaps-music section, the handclaps-voice section, the bustling sound-music sections, and the bustling sound-voice section; two discriminants are determined and held by each noise/non-noise discriminant holding module.

In this way, in the present embodiment, the noise level determining module 205 estimates the noise level by making use of a plurality of discriminants set according to the environment. That is, based on the estimation result obtained from each discriminant, the noise level determining module 205 determines whether the noise is present in a comprehensive manner. That leads to an enhancement in the reliability of noise determination.

However, the nature of the linear discriminants used by the noise level determining module 205 is such that the signals are classified into two types. Consequently, if the non-handclap portion includes not only music but also voice, then it becomes difficult to make clear distinction between the sound types. In that regard, the discriminants can be set for more detailed discrimination conditions. For example, a discriminant for handclap-music (for determining handclaps mixed in music) and a discriminant for handclap-voice (for determining handclaps mixed in voice) can be set separately. That enables achieving enhancement in the determination accuracy.

For example, assume that, regarding a normal voice section, the discriminant for handclap-music is indicating the presence of handclaps (noise). Such a situation occurs when the frequency characteristic of some imperceptible background sound or dark noise other than the voice component happens to have a high SFM value (closer to handclaps as compared to music) in a bandwidth set for handclaps. In such a case, if, by also referring to the discriminant for handclap-voice, it is determined that the discriminant value does not suggest that handclaps are mixed in voice (and that the voice level in the corresponding subframe is higher than the music level); then the noise determination using the discriminant for handclap-music can be eliminated. Such a procedure can be expanded for enhancing the versatility of multiple determinations by means of a plurality of discriminants.

In order to combinedly determine a plurality of discriminants, it is possible to think of various methods such as an AND condition method in which all of the discriminants need to be satisfied, an OR condition method in which at least one discriminant is satisfied, a majority method, and an inter-discriminant weighting method. The base score represents the function value of the score values {Sn1 to Snr} (hereinafter, also referred to as “discriminant value list”) obtained from the discriminants.

The noise level correcting module 206 corrects, based on the base score Sn_base calculated within a certain period of time, each base score according to the detection state of the noise level within that certain period of time and then calculates the noise level.

The level adjusting module 207 makes inter-level adjustments with respect to the voice level and the music level corrected by the voice/music level correcting module 203 and with respect to the noise level corrected by the noise level correcting module 206. More particularly, in the processing performed by the voice/music level correcting module 203, momentary erroneous detection can be prevented. However, if sound components such as handclaps or bustling sound that are considered to be noise are present, then the feature quantity distribution becomes confusing thereby leaving open the possibility of an erroneous increase in the music level. Hence, depending on the noise level, the level adjusting module 207 makes adjustment in the music level. In the present embodiment, since the noise level is obtained independent of the voice level and the music level, it becomes possible to make adjustment in the voice level or the music level with higher accuracy as compared to the conventional technology.

The DSP 208 performs sound quality correction of the input audio signal according to the post-adjustment voice level, the post-adjustment music level, and the post-adjustment noise level. Regarding the specific sound quality correcting method using those levels, it is possible to implement any method including the known methods.

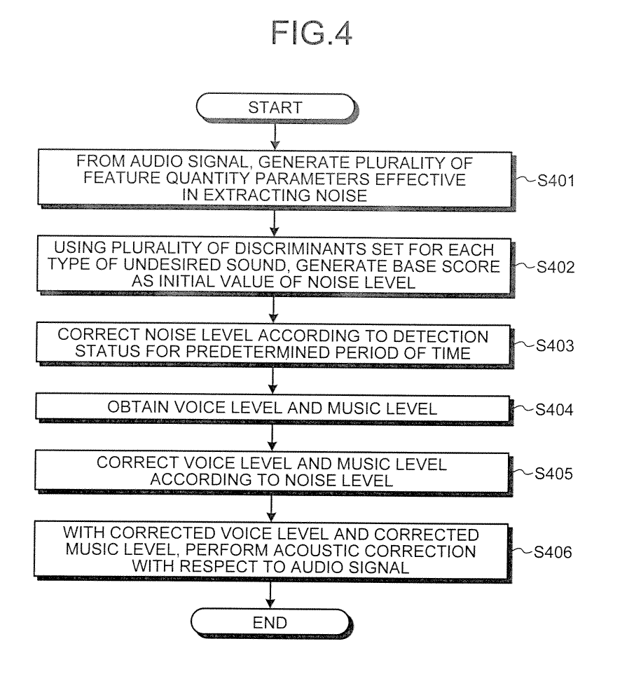

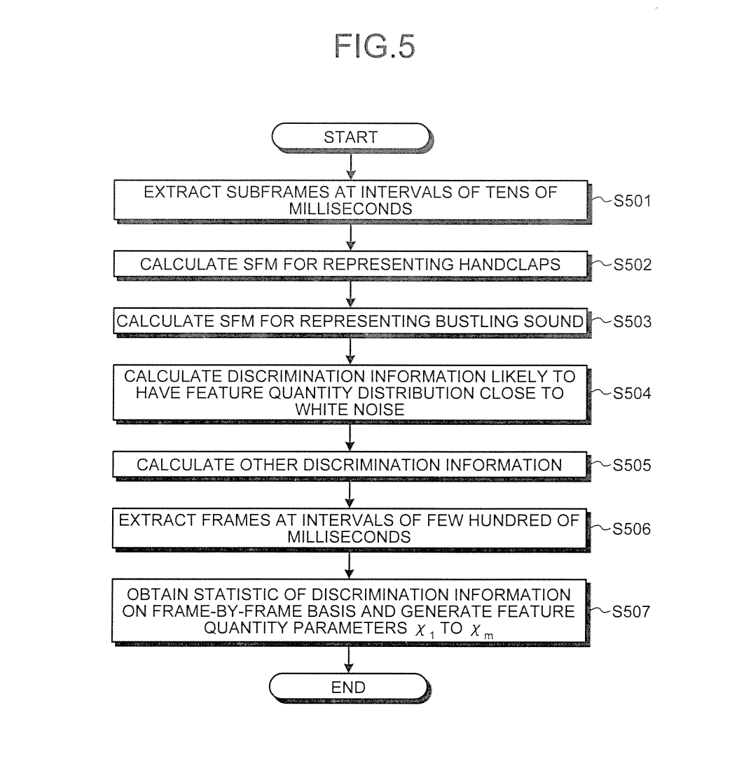

Explained below are operations that are associated to the noise present in an audio signal and that are performed in the audio processing module 57 of the digital television broadcast receiver 1 according to the present embodiment. FIG. 4 is an exemplary flowchart of the sequence of operations performed in the audio processing module 57 according to the present embodiment. Meanwhile, it is herein assumed that alongside the operations performed from S401 to S403 illustrated in FIG. 4, the operations for deriving the voice level and the music level are also performed.

Firstly, the noise feature quantity extracting module 204 generates, from an input audio signal, a plurality of feature quantity parameters that are effective in extracting the noise (S401).

Then, the noise level determining module 205 makes use of a plurality of discriminants set for each type of undesired sound and estimates the base score Sn_base that represents the base of the noise level representing the noise-like property (S402).

Subsequently, the noise level correcting module 206 corrects the noise level according to the detection status for a predetermined period of time (S403).

Then, the level adjusting module 207 obtains the voice level and the music level from the voice/music level correcting module 203 (S404) and obtains the noise level from the noise level correcting module 206.

Subsequently, according to the noise level, the level adjusting module 207 corrects the voice level and the music level (S405).

Lastly, with the corrected voice level and the corrected music level, the DSP 208 performs acoustic correction with respect to the audio signal (S406).

As a result of the abovementioned sequence of operations, the audio signal is subjected to acoustic correction according to the music level and the voice level that are adjusted according to the noise level extracted with a high degree of accuracy. Thus, it becomes possible to perform acoustic correction in a more pertinent manner.

Given below is the explanation regarding the method of generating feature quantity parameters that is implemented by the noise feature quantity extracting module 204 at S401 illustrated in FIG. 4. FIG. 5 is an exemplary flowchart for explaining the sequence of operations in the above-mentioned method implemented by the noise feature quantity extracting module 204.

Firstly, the noise feature quantity extracting module 204 partitions an input audio signal into frames, divides each frame into subframes, and then extracts the subframes (S501).

Then, on a subframe-by-subframe basis, the noise feature quantity extracting module 204 calculates the SFM for the noise representing handclaps (S502). Moreover, on a subframe-by-subframe basis, the noise feature quantity extracting module 204 calculates the SFM for the noise representing bustling sound (S503).

Subsequently, on a subframe-by-subframe basis, the noise feature quantity extracting module 204 calculates, as discrimination information, a feature quantity that is likely to have the feature quantity distribution close to white noise (S504).

Moreover, the noise feature quantity extracting module 204 calculates other discrimination information on a subframe-by-subframe basis (S505). As a result, it is assumed that m number of types of discrimination information is calculated.

Then, with respect to each subframe, the noise feature quantity extracting module 204 extracts discrimination information for a frame that includes the abovementioned subframe and subframes positioned before and after that subframe (S506).

Subsequently, the noise feature quantity extracting module 204 obtains a statistic of the discrimination information extracted on a frame-by-frame basis and generates feature quantity parameters χ₁ to χₘ on a subframe-by-subframe basis (S507).

The noise level is then generated on the basis of the feature quantity parameters χ₁ to χₘ.

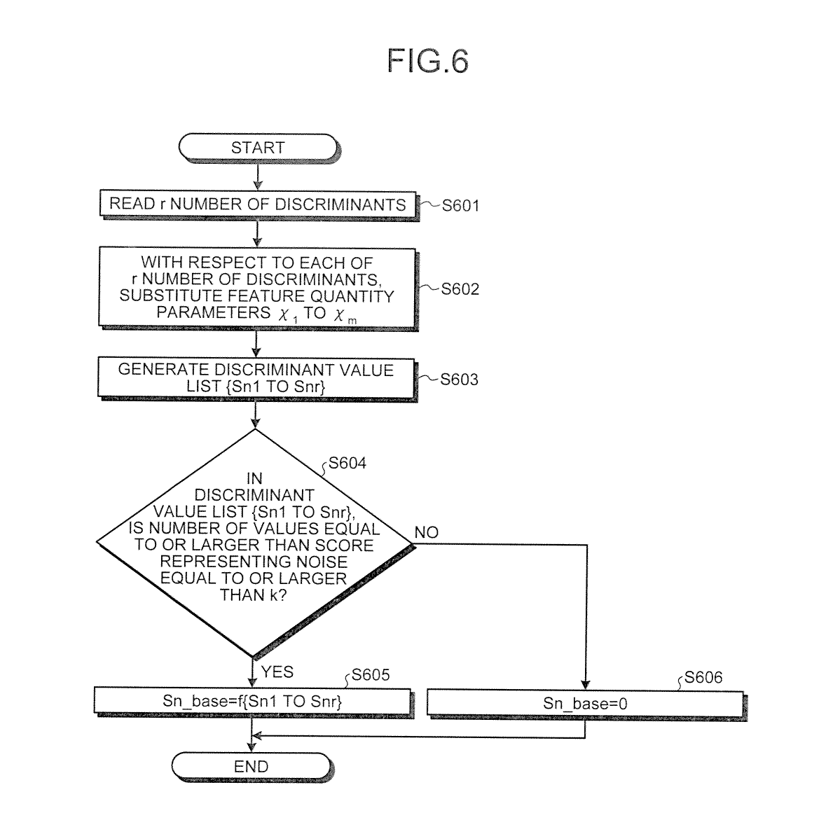

Given below is the explanation regarding the method of calculating the base score Sn_base as the base of the noise level. That method is implemented by the noise level determining module 205 at S402 illustrated in FIG. 4. FIG. 6 is an exemplary flowchart for explaining the sequence of operations in the abovementioned method implemented by the noise level determining module 205.

Firstly, the noise level determining module 205 reads the r number of discriminants held by the noise/non-noise discriminant holding modules (S601).

Then, with respect to each of the r number of discriminants, the noise level determining module 205 substitutes the feature quantity parameters χ₁ to χₘ (S602).

Subsequently, the noise level determining module 205 generates a discriminant value list {Sn1 to Snr} that is a list of score values calculated from each discriminant in which the feature quantity parameters have been substituted (S603).

Then, the noise level determining module 205 determines whether, in the discriminant value list {Sn1 to Snr}, the number of values equal to or larger than a score representing the noise is equal to or larger than k (S604). The score representing the noise can be, for example, “0”. In that case, a positive discriminant value means that the noise is determined to be present. Moreover, the number k is equal to or less than the number r and can be set to an appropriate number as the standard for determining the presence of noise.

If the number of values equal to or larger than a score representing the noise is equal to or larger than k (Yes at S604), then the noise level determining module 205 calculates the base score Sn_base from a function f in which “Sn1, , Snr” are substituted (S605). On the other hand, if the number of values equal to or larger than a score representing the noise is smaller than k (No at S604), then the noise level determining module 205 sets ‘0’ in the base score Sn_base (S606). That is, if the number of such values is smaller than k, then the noise level is set to the initial value under the presumption that there is little possibility of noise being present.

By performing the abovementioned sequence of operations, the noise level determining module 205 estimates the base score Sn_base as the base of the noise level. The base score Sn_base is then subjected to correction/smoothing by the noise level correcting module 206.

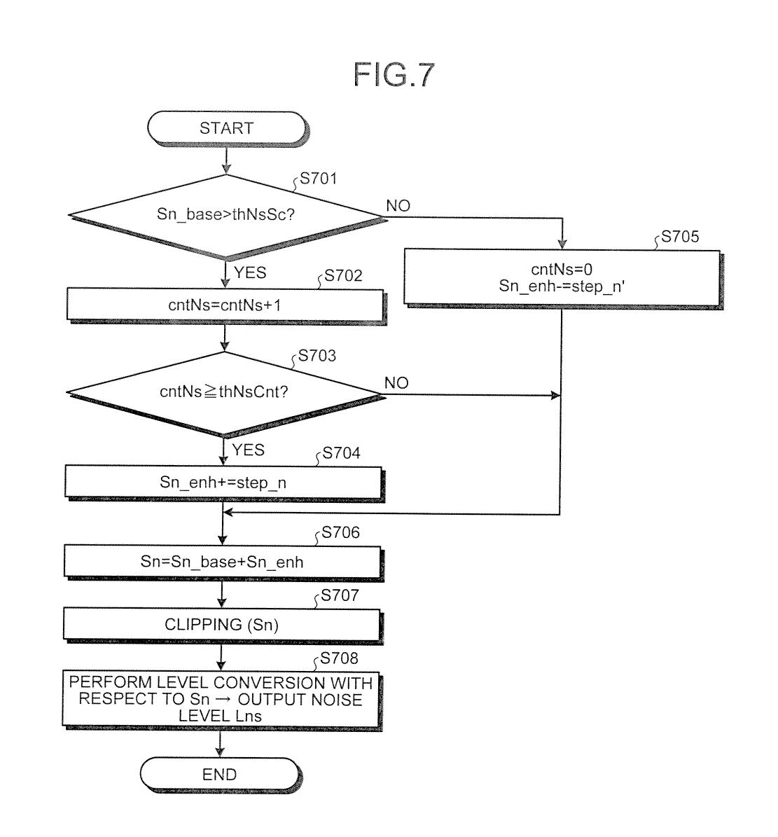

Given below is the explanation regarding the method of generating the noise level from the base score Sn_base. That method is implemented by the noise level correcting module 206 at S403 illustrated in FIG. 4. FIG. 7 is a flowchart for explaining the sequence of operations in the abovementioned method implemented by the noise level correcting module 206.

Firstly, the noise level correcting module 206 determines whether the base score Sn_base exceeds a threshold value thNsSc of the noise-like property (S701).

If the base score Sn_base exceeds the threshold value thNsSc (Yes at S701), then the noise level correcting module 206 increments a noise continuity counter variable cntNs by one (S702).

Then, the noise level correcting module 206 determines whether the noise continuity counter variable cntNs is equal to or larger than a noise continuity threshold value thNsCnt (S703). If the noise continuity counter variable cntNs is smaller than the noise continuity threshold value thNsCnt (No at S703), the system control proceeds to S706.

On the other hand, if the noise continuity counter variable cntNs is equal to or larger than the noise continuity threshold value thNsCnt (Yes at S703), then the noise level correcting module 206 assumes that the score values that can be determined to represent noise have appeared in succession for a sufficient number of times and adds step_n to a correction variable Sn_enh of the base score (S704). Herein, step_n is assumed to set to a predetermined value.

Subsequently, the noise level correcting module 206 adds the correction variable Sn_enh to the base score Sn_base to calculate a noise score Sn that is corrected by taking into account the past determination statuses (S706).

Meanwhile, if the base score Sn_base does not exceed the threshold value thNsSc (No at S701), then the noise level correcting module 206 assumes that the noise-like property is not prominent, and resets the noise continuity counter variable cntNs to “0” and subtracts step_n′ from the correction variable Sn_enh of the base score (S705). Herein, step_n′ is assumed to set to a predetermined value.

Subsequently, to the base score Sn_base, the noise level correcting module 206 adds the correction variable Sn_enh that has decreased at Step S705 to calculate the noise score Sn (S706). Meanwhile, except being updated on a subframe-by-subframe basis at S704 and S705, the correction variable Sn_enh continually holds a value without being initialized.

As described in the abovementioned sequence, when a large value appears in succession as the base score Sn_base, the noise level correcting module 206 steadily increases the noise score Sn. On the other hand, when the base score Sn_base is a small value, the noise level correcting module 206 reduces the correction variable Sn_enh in a stepwise fashion using step_n′. As a result, it becomes possible to prevent sudden fluctuation in the noise score Sn.

Besides, in order to prevent the noise score Sn from endlessly increasing or decreasing, the noise level correction module 206 performs clipping so that the noise score Sn remains within the range of a predetermined upper limit and a predetermined lower limit (for example, between an upper limit of “0” and a lower limit of “1.0”) (S707).

Subsequently, the noise level correcting module 206 converts the clipped value into a noise level Lns that takes a value within a predetermined range (for example, an integer between “1” to “12”) (S708). Asa result, the eventual noise level Lns is obtained.

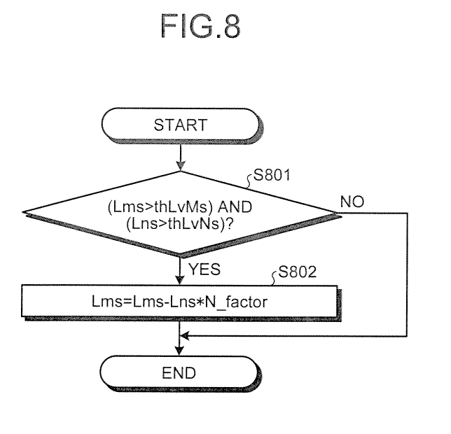

Given below is the explanation regarding the method of correcting the music level that is implemented by the level adjusting module 207 at S405 illustrated in FIG. 4. FIG. 8 is an exemplary flowchart for explaining the sequence of operations in the abovementioned method implemented by the level adjusting module 207.

Firstly, the level adjusting module 207 determines whether a music level Lms is larger than a music threshold level thLvMs and determines whether the noise level Lns is larger than a noise threshold level thLvNs (S801).

If the music level Lms and the noise level Lns are larger than the respective threshold levels (Yes at S801), then the level adjusting module 207 subtracts, from the music level Lms, a value obtained by multiplying the noise level Lns with N_factor (S802) and ends the processing. Herein, N_factor is a value set in advance for adjusting the noise level Lns.

On the other hand, even if either one of the music level Lms and the noise level Lns is smaller than the corresponding threshold level (No at S801), then the level adjusting module 207 ends the processing without performing any operation.

By implementing the abovementioned method, it becomes possible to perform appropriate adjustment regarding music-noise for which erroneous detection is relatively easy to occur. Although the explanation is given with reference to the adjustment regarding music-noise for which erroneous detections is relatively easy to occur, it is also possible to perform an identical adjustment regarding voice-noise.

In the audio processing module 57 according to the present embodiment, the abovementioned configuration makes it possible to identify the noise level Lns with a high degree of accuracy.

That is, in the audio processing module 57 according to the present embodiment, since the noise level determining module 205 is configured to hold discriminants for each type of undesired sound, it becomes possible to extract the noise level corresponding to various undesired sounds that are likely to be present in an audio signal. Therefore, as compared to the conventional technology, the presence of noise can be determined with a higher degree of accuracy.

Moreover, in the audio processing module 57 of the digital television broadcast receiver 1 according to the present embodiment, the noise level determining module 205 makes use of a plurality of discriminants, which are set for each type noise to be determined, with respect to the feature quantity parameters extracted from the audio signal. That makes it possible to distinguish between the voice, the music, and the noise in a robust manner. Therefore, it is possible to enhance the discrimination accuracy of sections likely to be confused such as a music section and a noise section in an audio signal.

Furthermore, in the audio processing module 57 according to the present embodiment, based on the robust discrimination result, the details of sound quality correction can be flexibly changed according to the signal section. Therefore, it is possible to perform sound quality correction in a pertinent manner.

Besides, in the audio processing module 57 according to the present embodiment, in order to enhance the noise detection accuracy, the weighting coefficients of the discriminants corresponding to the target noise types for detection accuracy enhancement can be subjected to change or relearning. Thus, the enhancement in the discrimination method is not difficult.

Moreover, in the audio processing module 57 according to the present embodiment, the noise feature quantity extracting module 204 performs weighting according to the types of undesired sound such as handclaps or bustling sound only after changing the feature quantity parameters, which represent the flatness of the frequency structure, to a bandwidth distribution that corresponds to the types of undesired sound. Hence, the discrimination for each type of undesired sound can be performed with more precision.

Furthermore, in the audio processing module 57 according to the present embodiment, the inter-level adjustment made by the level adjusting module 207 results in preventing, as much as possible, the effect of erroneous detection regarding music-noise.

Moreover, the noise level determining module 205 can be set to make use of both a discriminant for handclap-music and a discriminant for handclap-voice to improve the detection accuracy. Meanwhile, regarding music, it is possible to make further subdivisions according to the differing trends.

Besides, since the noise level correcting module 206 adjusts the base score Sn_base according to the detection status for a predetermined period of time, sound quality correction can be performed in a smooth manner.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sound information determining apparatus comprising:
a holding module configured to hold a plurality of determining techniques, each of which determines, with respect to a noise of each type that may be present in an input audio signal, whether the noise of corresponding type is present according to a noise characteristic; and
a determining module configured to determine whether noise is present in the input audio signal by making use of some of the plurality of the determining techniques held with respect to the noise of each type.

2. The sound information determining apparatus of claim 1, wherein
the determining technique held by the holding module is a discriminant for determining presence of the noise of corresponding type from flatness of a frequency distribution of the input audio signal, and
in the discriminant, regarding the frequency distribution of the input audio signal, weighting to a bandwidth is performed according to a characteristic of the noise of corresponding type.

3. The sound information determining apparatus of claim 1 further comprising:
a noise level deriving module configured to derive, according to a determining result indicating whether noise is present in the input audio signal as determined by the determining module, a noise level representing an extent of noise;
a music level obtaining module configured to obtain a sound information level representing an extent to which music is present or voice is present in the input audio signal;
an adjusting module configured to adjust the sound information level according to the noise level; and
a correcting module configured to perform correction of the input audio signal according to the sound information level adjusted by the adjusting module.

4. The sound information determining apparatus of claim 1, further comprising a feature quantity extracting module configured to extract a feature quantity representing a characteristic of the noise of each type, wherein
with respect to the feature quantity extracted by the feature quantity extracting module, the determining module is configured to determine whether noise is present in the input audio signal by making use of the plurality of the determining techniques held with respect to the noise of each type.

5. A sound information determining method implemented in a sound information determining apparatus including a memory module configured to store a plurality of determining techniques each of which determines, with respect to a noise of each type that may be present in an input audio signal, whether the noise of corresponding type is present according to a noise characteristic, the sound information determining method comprising:
determining, by a determining module, whether noise is present in the input audio signal by making use of the plurality of the determining techniques stored in the memory module with respect to the noise of each type.
